(19) United States
(12) Patent Application Publication
(10) Pub. No.: US 2006/0251005 A1
(43) Pub. Date: Nov. 9, 2006

(54) Cellular communication system messaging

(76) Inventor: Gerard Foster, Swindon Wiltshire (GB)

Correspondence Address: MOTOROLA, INC., 1303 EAST ALGONQUIN ROAD, IL01/3RD, SCHAUMBURG, IL, 60196, US

(21) Appl. No.: 10/558,838

(22) PCT Filed: Jun. 2, 2004
(86) PCT No.: PCT/EP04/51000

§ 371 Date: Nov. 29, 2005

(30) Foreign Application Priority Data
Jul. 17, 2003 (GB) 0316835.8

(51) Int. Cl. H04Q 7/00

(52) U.S. Cl. 370/328

(57) ABSTRACT

A method of operating a cellular communications system, the method comprising a subscriber unit, e.g. mobile station or user equipment such as a mobile telephone, participating in a session context such as a session conference call that has been set up using a session initiation protocol such as Internet IP Session Initiation Protocol; a first user inputting a voice message to the subscriber unit; and the subscriber unit transmitting the voice message to a second user by means of the session context. The voice message is input on a push-to-talk basis and transmitted over a push-to-talk bearer path.

### FIELD OF THE INVENTION

The present invention relates to voice messaging in cellular communications systems, including for example Universal Mobile Telecommunications System (UMTS), General Packet Radio Service (GPRS) and Global System for Mobile Telecommunication (GSM) systems.

### BACKGROUND OF THE INVENTION

Cellular communications systems are well known. Examples of established harmonised cellular radio communications systems are Global System for Mobile Telecommunication (GSM) and General Packet Radio Service (GPRS) systems. A further harmonised standard being introduced is the Universal Mobile Telecommunications System (UMTS).

Such cellular communications systems allow conventional voice calls to be made and received by a user of a subscriber unit, e.g. a mobile telephone. Additionally a further service called Short Message Service (SMS) allows other data to be sent or received. A common use of SMS is to send and receive text messages. Such text messages do not require a call as such to be set up to the intended recipient of the text message. However, there is no convenient way to send a voice message to a recipient without making a call to that recipient.

The following aspects of cellular communications systems are known in themselves, but are not conventionally considered to relate to convenient ways of sending voice messages without making a dedicated call to the recipient of the message.

Packet-based cellular communication systems are known (for example the previously mentioned GPRS and UMTS systems). Furthermore, such cellular communications systems may be connected to the Internet and communicate therewith using the Internet Protocol (IP). In this situation Internet connection may be provided to an end user using a subscriber unit such as a mobile telephone, usually referred to as a mobile station (MS) in GPRS terminology and user equipment (UE) in UMTS terminology.

Under IP, sessions may be set up using a part of the IP Protocol suite called the Session Initiation Protocol (SIP). This provides a link between two or more users over the Internet. Either data or voice may be communicated over the link. When voice, this is performed using a protocol known as Voice over IP.

Chat rooms and the like are a well known Internet facility. One way these are implemented is using SIP with the concept of “Presence”. Presence is a facility whereby other users are informed as to the current presence status of a user, e.g. whether that user is logged on.

Quite separate from the above considerations, another telecommunications technology is push-to-talk (PTT) radio. Here, two or more users talk to each other on dedicated radio frequencies, with the pressing of a button on the handset when talking. Conventionally, the PTT button operates by the network providing a common uplink talk channel and a corresponding broadcast channel for the group of users concerned and users accessing that common channel to talk by pressing the PTT button on their mobile device to communicate.

### SUMMARY OF THE INVENTION

In a first aspect, the present invention provides a method of operating a cellular communications system, as claimed in claim 1.

In a further aspect, the present invention provides a cellular communications subscriber unit, as claimed in claim 9.

In a further aspect, the present invention provides a Serving Call State Control Function, as claimed in claim 15.

In a further aspect, the present invention provides a Media Gateway Function, as claimed in claim 16.

In a further aspect, the present invention provides a storage medium storing processor-implementable instructions, as claimed in claim 18.

In a further aspect, the present invention provides a storage medium storing processor-implementable instructions, as claimed in claim 19.

In a further aspect, the present invention provides a storage medium storing processor-implementable instructions, as claimed in claim 20.

The present invention provides a way of sending voice messages over a cellular communications system without making a dedicated call to the recipient of the message.

The present invention provides a method of operating a cellular communications system, the method comprising a subscriber unit, e.g. mobile station or user equipment such as a mobile telephone, participating in a session context such as a session conference call that has been set up using a session initiation protocol such as Internet IP Session Initiation Protocol; a first user inputting a voice message to the subscriber unit; and the subscriber unit transmitting the voice message to a second user by means of the session context. The voice message is input on a push-to-talk basis and transmitted over a push-to-talk bearer path.

### BRIEF DESCRIPTION OF THE DRAWINGS

Embodiments of the present invention will now be described, by way of example only, with reference to the accompanying drawings, in which:

FIG. 1 is a schematic illustration of part of a cellular communication system 1 compliant with, and containing network elements of, UMTS and GPRS;

FIG. 2 is a simplified external view of a User Equipment (UE);

FIG. 3 is a block diagram schematically illustrating certain functional units of the UE of FIG; 2; and

FIG. 4 is a process flowchart showing certain process steps carried out in an embodiment of the present invention.

### DESCRIPTION OF PREFERRED EMBODIMENTS

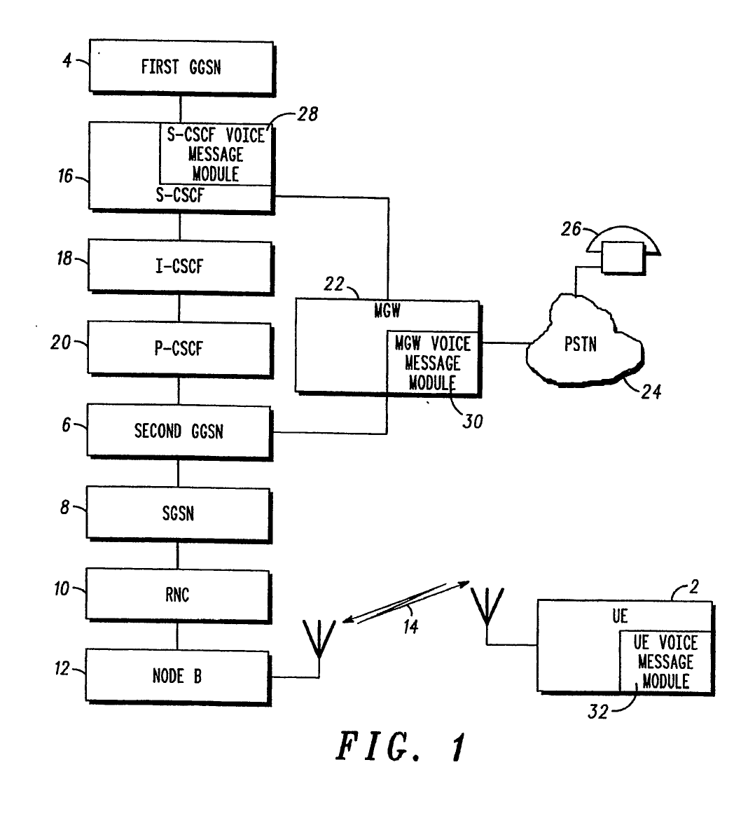

FIG. 1 is a schematic illustration of part of a cellular communication system 1 compliant with, and containing network elements of, UMTS and GPRS.

The UMTS/GPRS cellular communication system 1 is shown providing service to a UE 2, which in this embodiment is a mobile telephone. FIG. 1 shows network elements of the home location of UE 2, and network elements of a visitor location of UE2. In FIG. 1, UE2 is shown as currently in the visitor location.

In the home location, the system 1 comprises a first Gateway GPRS Support Node (GGSN) 4. Likewise, in the visitor location, the system 1 comprises a second GGSN 6. The system 1 further comprises a Serving GPRS Support Node (SGSN) 8 which is coupled to the second GGSN 6. The SGSN 8 performs high level switching, including determining the location of particular UEs by means of accessing location registers (not shown).

The system 1 further comprises, coupled to the SGSN 8, a radio network controller (RNC) 10, to which is coupled a base transceiver station, known in UMTS as a Node-B 12. The Node-B 12 transmits and receives radio signals to and from UEs, in this example UE 2, effectively forming a radio link 14.

The system 1 further comprises a number of Call Sate Control Functions (CSCFs) which provide interaction between the home location and visitor location parts of the system 1. These include a Serving-CSCF (S-CSCF) 16, an Interrogating-CSCF (I-CSCF) 18 and a Proxy-CSCF (P-CSCF) 20. The S-CSCF 16 is coupled to the first GGSN 4. The P-CSCF 20 is coupled to the second GGSN 6. The I-CSCF 18 is coupled to the S-CSCF 16 and the P-CSCF 20.

The system 1 further comprises a Media Gateway Function (MGW) 22 which, for providing a gateway function to external systems, is coupled to a public switched telephone network (PSTN) 24. Within system 1, the MGW 22 is coupled to the S-CSCF 16 and the second GGSN 6.

In this example, a message recipient telephone 26 is shown connected to the PSTN 24. In other situations, e.g. those sessions that need to go outside an operator walled garden IP network (i.e. an effective network under the control of an operator, the operator being e.g. a cellular communication service provider such as Vodafone (Registered Trade Mark), including if applicable parts of other operators physical networks controlled by the walled garden operator), may be further routed through the Internet.

The system 1 as described above corresponds to a typical conventional arrangement and operates in conventional fashion to allow a user to make voice calls and data transmission from the visitor location to external connections such as the telephone 26. However, a conventional arrangement does not allow the user to send non-call voice messages to e.g. the telephone 26.

In the embodiments described below, certain of the network elements, namely the S-CSCF 16, the MGW 22 and the UE 2, have been adapted, by provision of respective voice message modules, to offer, and provide for, a voice message process, as will be described in more detail below. More particularly, the S-CSCF 16 is provided with a S-CSCF voice message module 28; the MGW 22 is provided with a MGW voice message module 30; and the UE 2 is provided with a UE voice message module 32.

However, this adaptation may be implemented in any suitable manner to provide suitable apparatus. The modules may consist of respective single discrete entities added to conventional example of the respective network elements, or may alternatively be formed by adapting existing parts of the respective conventional network elements, for example by reprogramming of one or more processors therein. As such the required adaptations may be implemented in the form of processor-implementable instructions stored on storage media, such as a floppy disks, hard disks, PROMs, RAMs or any combination of these or other storage media. Furthermore, whether separate entities or adaptations of existing parts or a combination of these, the modules may be implemented in the form of hardware, firmware, software, or any combination of these.

It is also within the contemplation of the invention that the process to be described below may alternatively be controlled, implemented in full or implemented in part by a module added to or formed by adaptation of any other suitable network elements or other part or parts of the communication system 1.

Further, in the case of other network infrastructures, implementation may be at any appropriate switching node such as any other appropriate type of base station, base station controller etc.

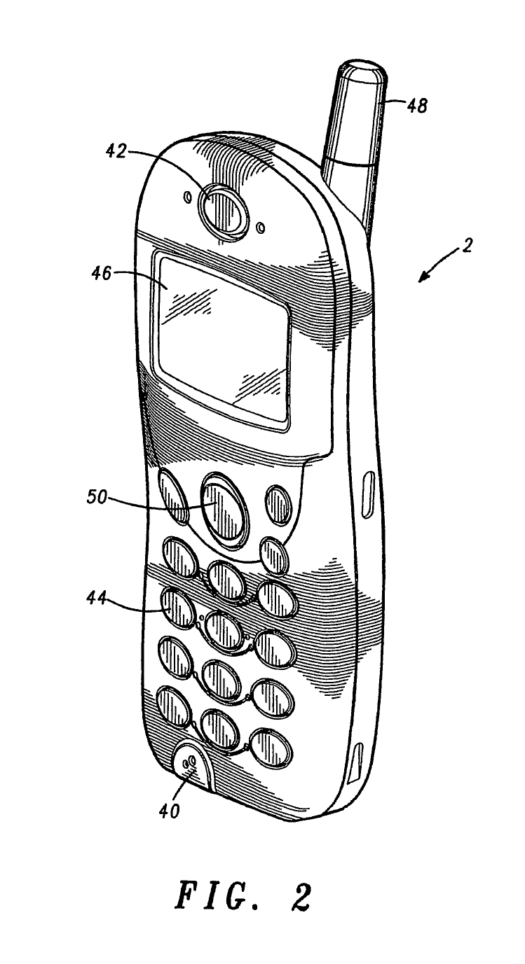

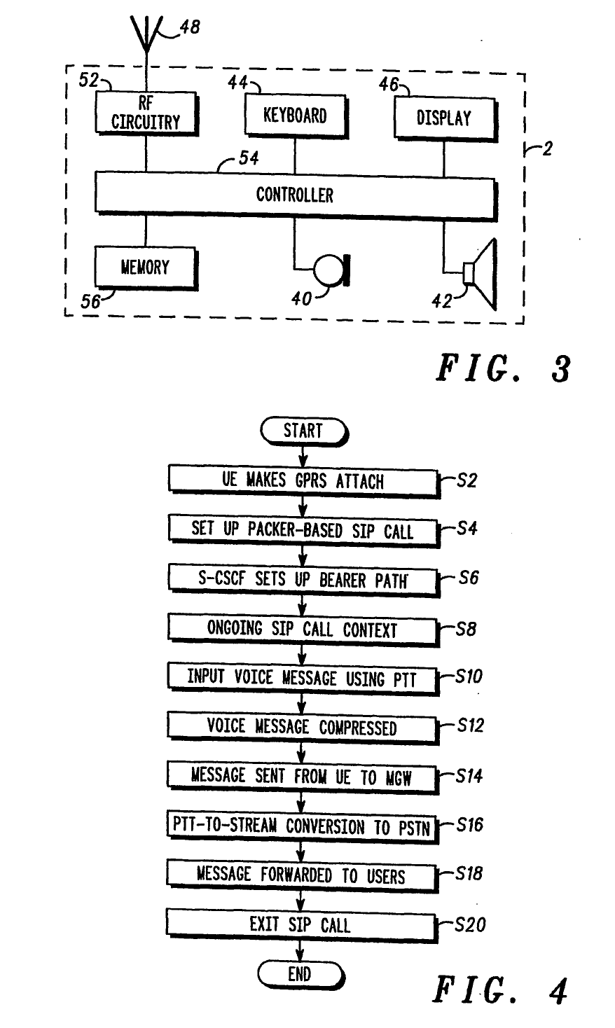

In this embodiment, the UE voice message module 32 provides a push-to-talk (PTT) key function, which is described further with reference to FIGS. 2 and 3, as follows.

FIGS. 2 and 3 are illustrations of UE 2, a mobile telephone. FIG. 2 is a simplified external view of UE 2; FIG. 3 is a block diagram schematically illustrating certain functional units of UE 2. The same reference numerals are used in the following description for the same parts appearing in both FIGS.

UE 2 comprises a microphone 40 and a loudspeaker 42 enabling a user of UE 2 to input speech and hear audio output respectively; a user interface in the form of a keyboard 44 enabling the user to input information and instructions such as telephone numbers to be called and for accessing menus and controlling various features of UE 2; a display 46 on which incoming or outgoing telephone numbers and other information is displayed; and RF circuitry 52 coupled to an antenna 48 for modulating, transmitting and receiving radio communications to and from Node-B 12, thereby providing the radio link 14.

UE 2 further comprises a controller 54, a memory 56, and a subscriber identity module (SIM) (not shown). The controller 54 is coupled to each of the RF circuitry 52, the key board 44, the display 46, the memory 56, the microphone 40, the loudspeaker 42 and the SIM. The controller 54 controls the overall operation of UE 2 in compliance with the UMTS specifications in conventional manner.

In this embodiment, the PTT function provided as part of the UE voice message module 32 includes a dedicated FIT key 50. This PTT key 50 is part of the keyboard 44, and is provided in addition to other conventional keys forming the keyboard 44. However, although a discrete key is provided, overall the PTT key function of this embodiment may be considered a so-called “soft PTT button”. More particularly, in operation the controller 54 responds to a user pressing the PTT key 50 to packetise, and cause to be transmitted, speech input by the user whilst pressing the button, as will be described more fully below. This control operation is another aspect of the provision of the UE voice message module 32. This is different to a conventional PTT button on a personal two-way mobile radio in which pressing the PTT interrupts the main radio function.

The process steps carried out under the present embodiment by the various network elements will now be described with reference to the process flowchart of FIG. 4.

At step s2, the UE 2 makes a GPRS attach to the core network in the visitor location (i.e. the SGSN 8 and the second GGSN 6) via the radio access network (i.e. the Node-B 12 and the RNC 10). This may be initiated by the user activating this process by input using the keyboard 44. Another possibility is that the UE2 may be programmed to perform this automatically, for example whenever the UE 2 is switched on.

At step s4, the UE 2 sets up a packet-based SIP call from the S-CSCF 16 to the PSTN 24. This may be initiated by the user activating this process by input using the keyboard 44. Another possibility is that the UE2 may be programmed to perform this automatically, for example as a following step after the UE 2 has made a GPRS attach in step s2.

The packet-based SIP call is, in more detail, an initiation or effective “log-on” to a SIP conference session. This is a conference call held under the SIP call control protocol.

The session is with one or more third party users forming a dosed group specified or identified by the user of UE 2. These third party users may be communicated with via the PSTN 24. The telephone number (in the case of telephones or other subscriber units) or other identification, e.g. IP address (in the case of computers) of these users may be input by the user of UE 2 as part of the process of initiating the SIP conference call. However, more likely, and more conveniently, the identities and contact details of the users are stored in memory 56, and used each time. The list may be updated by the user of UE 2 by input via the keyboard 44. These users may be referred to as “buddies”, the group as a “buddy group”, and the stored details as a “buddy list”. There are a plurality of third party users on the “buddy list” of UE 2 in this embodiment, one of which, by way of example, is the message recipient telephone 26.

The packet-based SIP call is set up as far as to the S-CSCF 16 in a conventional manner according to the UMTS and IP specifications, in this case according to Release 5/6 of the Third Generation Participation Project (3GPP) issued by ETSI. That is, the UE 2, being in a visited location/network, contacts the P-CSCF 20 of the visited network. Thereafter the P-CSCF 20 uses the I-CSCF 18 to find the S-CSCF 16 in the home network.

Then, at step s6, the S-CSCF 16, in particular the S-CSCF voice message module 28, sets up a bearer path from the UE 2 to the PSTN 24. The bearer path runs from the UE 2, through the second GGSN 6, through the MGW 22, and to the PSTN 24. This bearer path may be considered to be a PTT-based bearer path, as it will be used for, and respond to, PTT input from the UE 2. The bearer path is set up so as to comply with the SIP-based Instant Messaging Service (MS), Multimedia Messaging (MMS) Presence service, as specified in the IETF Presence and Sipping working groups.

From this stage there exists an ongoing SIP conference call context. This status remains until the session is terminated. For convenience, the ongoing status of SIP call context is represented in the flowchart of FIG. 4 as a discrete step s8. The system is now set up so that the user can initiate a voice message to any of the third party users without setting up any further dedicated call, as follows.

At step s10, the user inputs a voice message to UE 2 by speaking into the microphone 40 whilst holding down the PTT key 50. The controller 54 packetises the input sound signal during the pushes on the PTT key 50.

At step s12, the controller 54 compresses the voice message (this may alternatively be performed before packetising). In this embodiment the voice message is compressed using SIP compression TCCB (Text Compression by Cache and Blanking). Fields that are repetitive, or known to be known at the receiver by previous knowledge, are individually cached and blanked.

At step s14, the compressed voice message is sent from the UE 2 to the MGW 22 over the PTT-based bearer path.

At step s16, the MGW 22, in particular the MGW voice message module 30, performs a PTT-to stream conversion towards the PSTN 24 i.e. the PTT-based signal is converted to a standard stream form compliant with Voice over IP, and the stream is transmitted to the PSTN 24. As part of this, the MGW voice message module 30 performs a PTT mobile voice coded format to PSTN/ISDN formatted voice translation. An exampe of this codec transcoding function would be:

“Input Speech Message [AMR]+any message header to played out PCM streamed voice on replay towards PSTN or VoIP towards IP operator walled garden or Internet”, where AMR is adaptive multi-rate, and PCM is pulse code modulation.

(Note, the optional compression/decompression process is done at both ends of the mobile system, e.g. for the mobile telephone to fixed user case and direction:

at the mobile telephone:
1) Record the speech message
2) Sample as say AMR(GSM)
3) Compress any speech message, control header (no need to compress the AMR speech as this is already well compressed)
4) Forward message
5) Decompress any control header
6) Convert to either the IP domain as VoIP or as PCM stream to PSTN.

Also, note the system does not necessarily need to be VoIP, it could for example be AMR, e.g. as most efficient way over air interface.

Note, in the example above, all of the control signalling is SIP compressed at the mobile telephone and decompressed at the Proxy CSCF 20.

At step s18, the message is forwarded from the PSTN 24 to the third-party users on the buddy list, such as message recipient telephone 26, which have also availed themselves of such a SIP conference call context.

Another possibility is to select a particular user or all users from the buddy list.

Thereafter the ongoing SIP call context remains in existence and may provide the basis for further PTT transmissions from the UE 2. At some stage the user of UE 2 may input to UE 2 that the call context should be ended, or this decision may be implemented on some automatic basis, e.g. as part of a power-down routine of the UE 2 when switched off, or at a given time of day, or according to any other suitable basis. When this occurs, at step s20, the controller 54 initiates ending of the SIP call context, in conventional SIP process manner.

The above described arrangement and process may additionally or instead be operated in reverse direction, that is voice messages may be received at UE 2 form telecommunications units, such as the message recipient telephone 26, attached to the PSTN 24. This is primarily a mobile to mobile service but on a fixed telephone phone the user, when connected to a mobile user, also has to anchor himself to the CSCF to become part of the chat group. This may be done via an interworking function triggered by an extended Supplementary Service flag that is agreed between Fixed and Mobile operator parties involved in the same interoperability agreement (this is allowed in both ITU-T and ETSI standards). One implementauon would be for the Supplementary Service trigger on the calling fixed terminal to be used in the voice message and the trigger would send the message to a voice mail server to be retrieved by the CSCF using a Fixed party Proxy SIP leg towards the PTT SIP server to communicate to the mobile user. In the above described embodiment, the voice message is compressed before transmission. This process is optional, and in other embodiments either different types of compression are performed or indeed no compression is performed.

In the above described embodiment, the UE 2 is in a visitor location and communication involving the home location requires use of the I-CSCF 18 and the P-CSCF 20 in addition to the S-CSCF 16. However, the invention is equally applicable when the UE 2 is in the home location, and hence the S-CSCF 16 can be used without needing to use the I-CSCF 18 and the P-CSCSF 20.

The above described embodiment is based on a UMTS/GPRS cellular communication system. However, in other embodiments, other suitable communications systems may be employed, for example a GSM/GPRS system.

In the above described embodiment, there is a plurality of buddies on the buddy list. However, in other embodiments, there may be just one buddy on the buddy list. This enables a voice message to be sent to a specific other user. In this case, one possible choice is for the user of UE 2 to specify his or her own landline voicemail as the buddy. Another possibility is for the home personal computer of the user to be specified.

In the above described embodiment, the UE 2 has only one buddy list. However, in other embodiments the UE 2 may have plural buddy lists stored therein, from which the user of UE 2 can choose.

In the above described embodiment, the PTT key is provided as a discrete key on UE 2. However, in other embodiments a PTT key facility may be provided in which an existing keys shared with other functions temporarily operates as the PTT key by virtue of previous input via menu navigation or similar processes. Another possibility is that rather than a key being held down as such, instead a key stroke is used to start an ongoing “PTT” phase, and a further key stroke used to end the ongoing “PTT” phase. Alternatively, inputs other than key strokes may be used to start and end a “PTT” phase, for example voice commands.

1. A method of operating a cellular communications system, the method comprising the steps of:
a subscriber unit of the cellular communications system participating in a set up of a session context using a session initiation protocol;
a first user inputting a voice message to the subscriber unit;
a voice message module converting the voice message to a data stream; and
the subscriber unit transmitting the data stream carrying the voice message to a second user by means of the session context without making a dedicated call, wherein the inputting, converting and transmitting steps are all performed within a single subsequent session.

2. A method according to claim 1, further comprising the subscriber unit initiating the session context using the session initiation protocol.

3. A method according to claim 1, wherein the voice message is input to the subscriber unit using a push-to-talk process.

4. A method according to claim 3, further comprising a push-to-talk bearer path being established from the subscriber unit to a gateway node, the voice message being transmitted over the push-to-talk bearer path.

5. A method according to claim 4, further comprising the gateway node performing push-to-talk to stream conversion.

6. A method according to of claim5 From 1, further comprising the step of compressing the voice message.

7. A method according to claim 1, wherein the session context is compliant with the Session Initiation Protocol, SIP, of the Internet Protocol, IP.

8. A method according to of claim 1, wherein the session context comprises use of the Multimedia Messaging, MMS, Presence service.

9. A cellular communications subscriber unit, comprising:
means for participating in a set up of a session context;
means for receiving an input voice message;
means for converting the voice message to a data stream; and
means for transmitting the data stream carrying the voice message by means of the session context without making a dedicated call, wherein the means for receiving, converting and transmitting are all performed within a single subsequent session.

10. A cellular communications subscriber unit according to claim 9, further comprising means for initiating the session context using a session initiation protocol.

11. A cellular communications subscriber unit according to claim 9, wherein the means for receiving an input voice message comprises push-to-talk means for receiving the input message by a push-to-talk process.

12. A cellular communications subscriber unit according to claims 9, further comprising means for compressing the voice message.

13. A cellular communications subscriber unit according to claim 9, wherein the session context is compliant with the Session Initiation Protocol, SIP, of the Internet Protocol, IP.

14. A cellular communications subscriber unit according to claims 9, wherein the session context comprises use of the Multimedia Messaging, MMS, Presence service.

15-20. (canceled)
